(19) United States
(12) Patent Application Publication
(10) Pub. No.: US 2010/0066274 A1
(43) Pub. Date: Mar. 18, 2010

(54) SWITCH ELEMENT FOR A MOVABLE FURNITURE PART

(76) Inventor: Mathias GRIMM, Altach (AT)

Correspondence Address: WENDEROTH, LIND & PONACK, L.L.P., 1030 15th Street, N.W.,, Suite 400 East, Washington, DC, 20005-1503, US

(21) Appl. No.: 12/621,898

(22) Filed: Nov. 19, 2009

Related U.S. Application Data
(63) Continuation of application No. PCT/AT2008/000171, filed on May 15, 2008.

(30) Foreign Application Priority Data
May 24, 2007 (AT) GM 334/2007

(51) Int. Cl. H02K 7/00; H01H 13/02

(52) U.S. Cl. 318/9; 200/345; 318/446

(57) ABSTRACT

The invention relates to a switch element comprising an actuating element that can be impinged upon by an energy accumulator and is mounted so that it can be moved along a trajectory. At least two energy accumulators are used to impinge the actuating element and the number of the energy accumulators impinging the actuating element varies in predetermined positions of the trajectory.

The present invention concerns a switch element comprising an actuating element which can be acted upon by a force storage means and which is mounted movably over a predetermined path, a drive device for a movable furniture part having a control or regulating device and an article of furniture comprising a movable furniture part and such a drive device.

Such switch elements are used for example in such a way that in its closed position the movable furniture part bears against the actuating element, whereby the application of a pulling or pushing force to the furniture part by a user results in a movement of the actuating element.

It is known for example for the force storage means to be in the form of a compression spring and for the actuating element to be arranged relative to the force storage means in such a way that, with a furniture part in the closed position, the actuating element is pressed in against the force of the compression spring by the furniture part bearing against the actuating element, over a part of the overall predetermined path. If now a user applies pressure to the furniture part in the closed position (it will be appreciated that a suitable play for the movement of the furniture part also has to be provided in the closed position of the furniture part) the actuating element is further moved against the force applied by the compression spring. That can be detected either by a sensor device for monitoring the movement of the actuating element or by way of suitably arranged switches, whereupon triggering of a drive device for the furniture part takes place.

If in contrast the user applies a pulling force to the furniture part in the closed position, if therefore for example he moves a drawer out of the furniture body somewhat or if he lifts a flap away from the furniture body somewhat, the result of this is that the actuating element, by virtue of the force applied by the compression spring, follows the furniture part over a portion of the predetermined path, which can also be detected by a sensor device for monitoring the movement of the actuating element or suitable switches and can be used for triggering a drive device of the furniture part.

A disadvantage with such a switch element is the fact that the neutral position (no triggering of the drive device) of the actuating element in which the furniture part is disposed in the closed position thereof is relatively poorly defined and can everywhere be on the characteristic curve of the force storage means over the predetermined path. That also involves reduced operating comfort and convenience as most users will find it agreeable if the switch element can be triggered at a precisely defined switching point.

The object of the invention is to develop a switch element of the general kind set forth, in such a way that the above-discussed disadvantages are overcome.

That object is attained by a switch element having the features of claim 1.

The desired switching points can be pre-defined by in-factory selection of the predetermined positions along the path over which the actuating element can move. In that respect it may be sufficient to provide only two force storage means so that only one predetermined position and thus a single defined switching point is implemented within the path over which the actuating element can move.

A switch element according to the invention can be used for example in a drive device for a movable furniture part, the control or regulating device of the drive device being connected to an interface or electric lines of the switch element. In that respect the term interface is to be interpreted broadly. By way of example it is also possible to provide for wireless signal transmission by radio or infrared.

A particularly preferred embodiment concerns a drive device for a movable furniture part, comprising a control or regulating device connected to an interface or electric lines of a switch element, and an electric motor triggerable by the control or regulating device for driving the furniture part, wherein the switch element has an actuating element which is mounted movably along a path and which can be acted upon by a force storage means having a characteristic curve and wherein the switch element triggers the electric motor by way of the control or regulating device by movement of the actuating element at a switching point, wherein there are provided at least two force storage means for acting on the actuating element and wherein the number of force storage means acting on the actuating element changes at predetermined positions on the path (S), whereby the gradient of the characteristic curve changes at those positions, of which positions a position within the path is in the form of a switching point of the switch element.

Such a drive device is suitable in particular for use in an article of furniture in which the furniture part in the closed position thereof bears against the actuating element of the switch element, thereby affording the possibility of triggering the drive device of the furniture part by pushing in the furniture part to the defined switching point or by pulling on the furniture part.

Further advantageous embodiments of the invention are defined in the appendant claims.

The invention will be described in greater detail hereinafter with reference to the accompanying Figures in which:

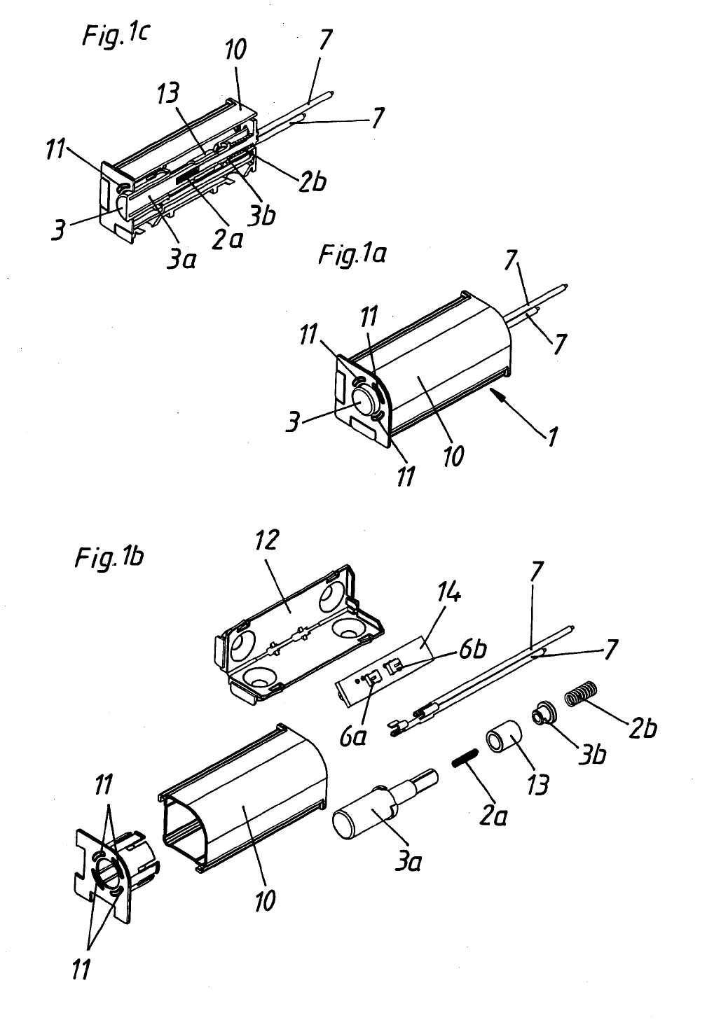

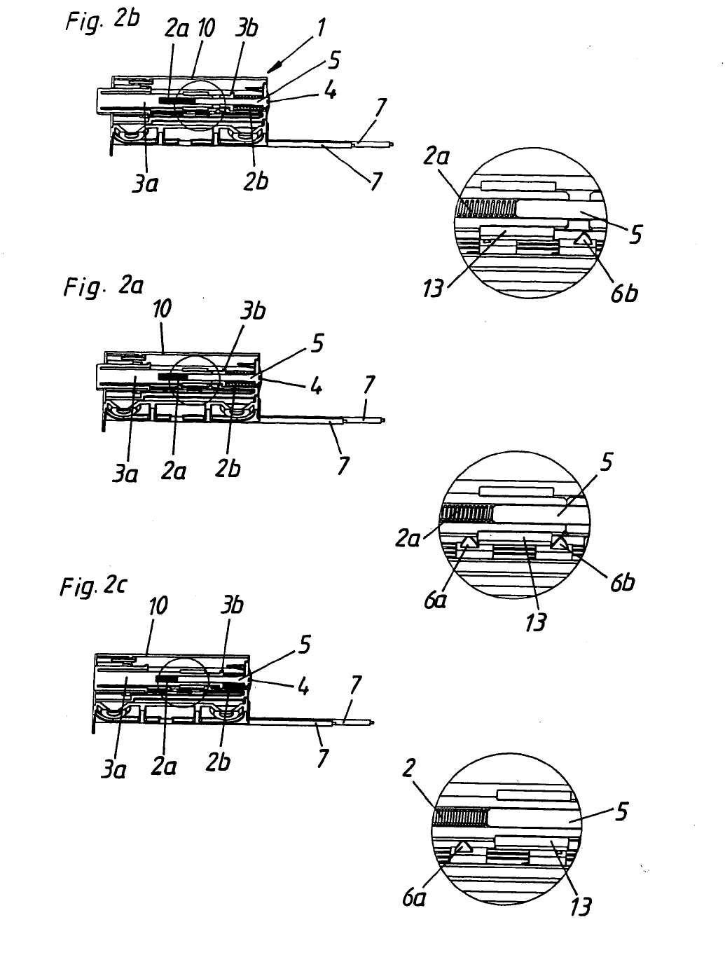

FIGS. 1a through 1c and 2a through 2c show a first embodiment of a switch element according to the invention,

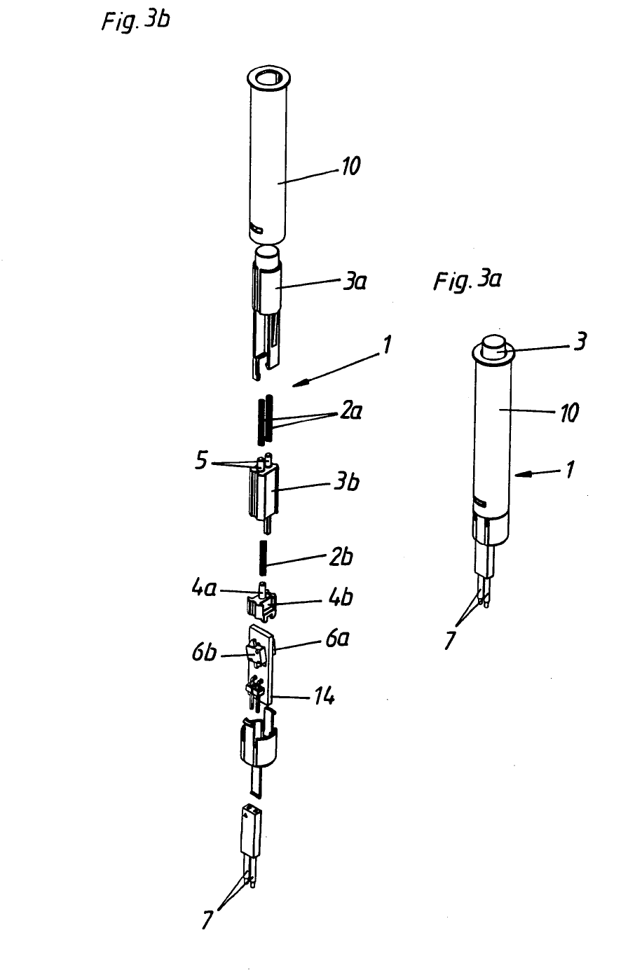

FIGS. 3a, 3b and 4a through 4c and 5a through 5d show a second embodiment of a switch element according to the invention,

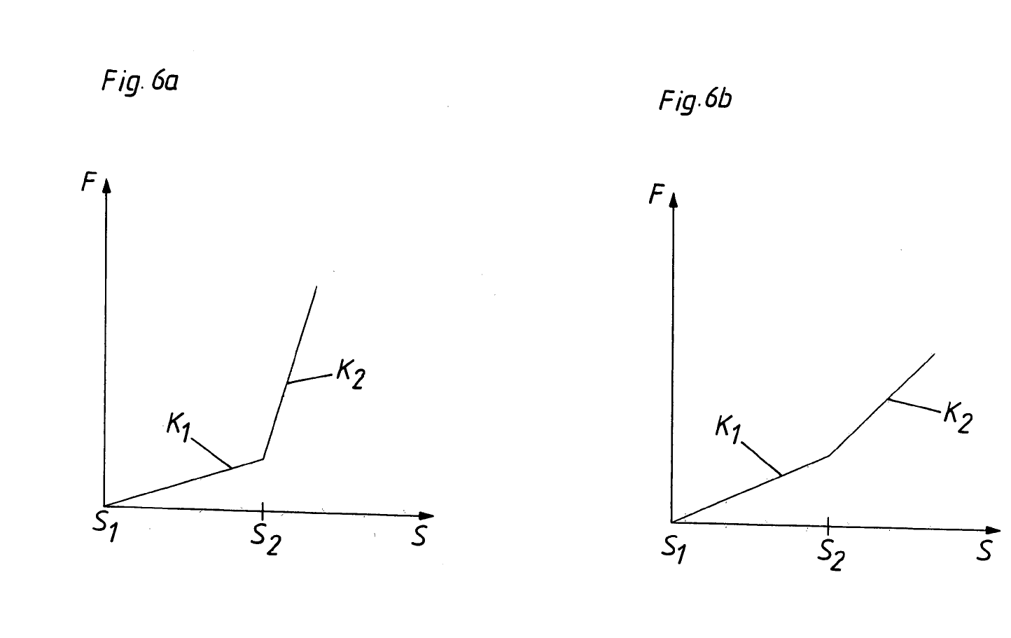

FIGS. 6a and 6b show by way of example the variation in force acting on the actuating element over the predetermined path when there are provided precisely two force storage means, for two different configurations,

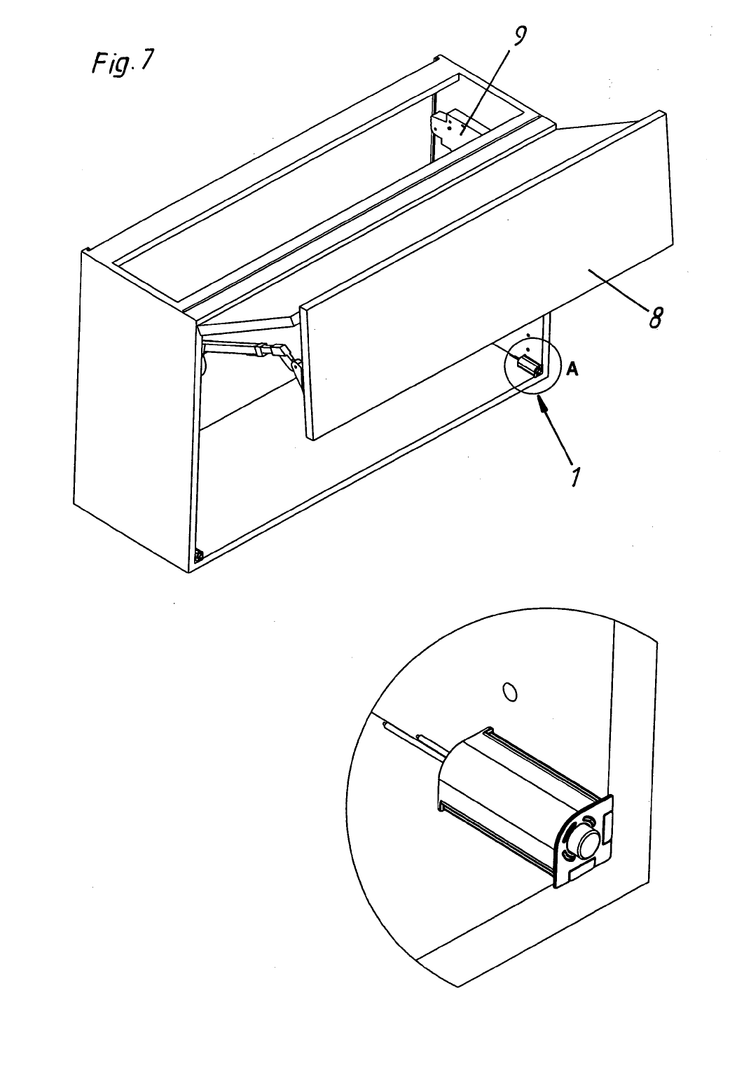

FIG. 7 shows an article of furniture comprising a drive device and a switch element according to the invention, and

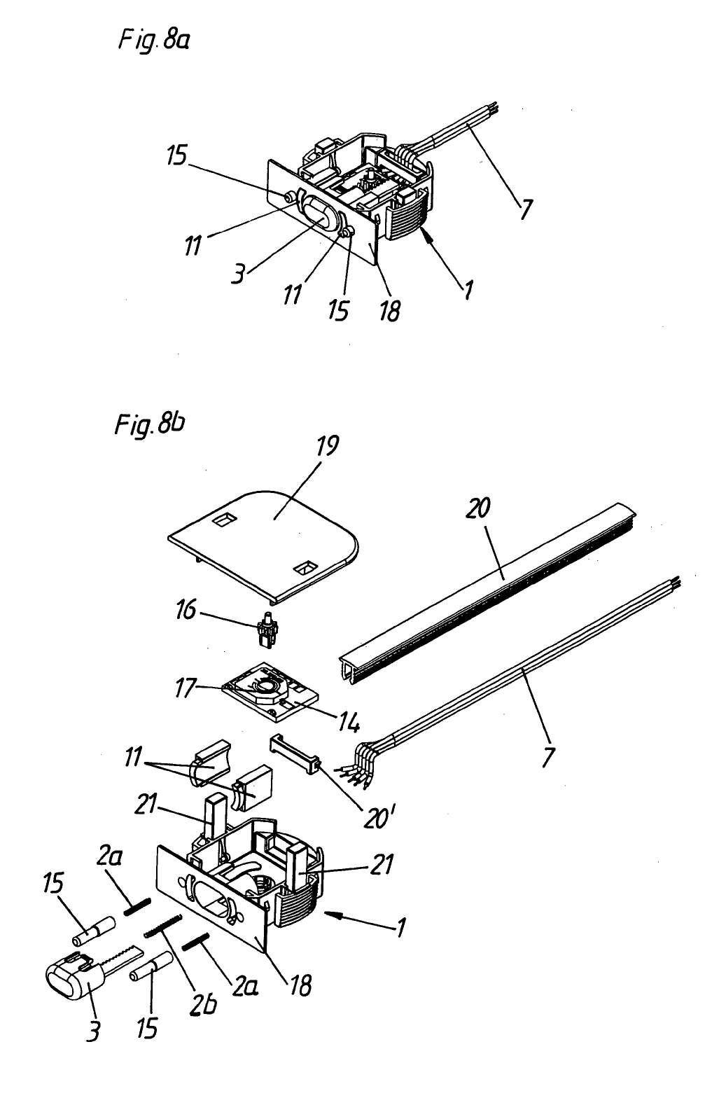

FIGS. 8a, 8b, 9a through 9c and 10 show a further variant of a switch element according to the invention.

The invention makes use of the fact that, in the arrangement of at least two force storage means 2a, 2b for acting on the actuating element 3, it is possible to establish a defined switching point for the switch element 1 by predetermining a position S₂, by altering the number of force storage means 2a, 2b acting on the actuating element.

A first position S₁ is for example at the beginning of the distance or path S which can be covered by the actuating element 3, that is to say when the actuating element 3 is fully extended and is not acted upon by any of the force storage means 2a, 2b. It will be noted however that that position S₁ is generally of subordinate significance for the invention as, in the mounted condition of the switch element 1 in or on an article of furniture the furniture part 8 is in that case outside its closed position. For example that position is adopted by the actuating element 3 when the furniture part 8 has been lifted off the furniture body or carcass by a user and then moved further away from the furniture body by a drive device 9. The actuating element 3 remains in that position S₁ until the furniture part 8 comes to bear against the actuating element 3 again. It will be noted however that in that case the furniture part 8 usually involves such a great momentum that it moves either of its own accord or by the force applied by a pull-in device, into the closed position, so that the user generally does not further notice the first defined switching point at position S₁.

It will be noted however that this is different if it is provided that the drive device 9 for the furniture part 8 also remains triggerable by the switch element 1 when the furniture part 8 is out of its closed position. That is particularly appropriate for example when the furniture part 8 is in the form of a flap as an opened flap is disposed at a relatively high position and it may be more comfortable for a user to trigger closure of the furniture part by actuation of the actuating element 3 of the switch element 1.

It will be noted however that an aspect of greater significance is that defined switching point which is implemented at the position S₂ on the path S, by the number of force storage means 2a, 2b which act on the actuating element 3 being increased from one to two. In other words in this embodiment it is provided that between the positions S₁ and S₂ the actuating element 3 is acted upon only by the first force storage means 2a to resist being pushed in and it is only at position S₂ that the second force storage means 2b also acts on the actuating element 3.

Preferably it is provided in that respect that the first force storage means 2a has already reached its maximum force at the position S₂. If the force storage means is for example in the form of a compression spring, that means that the compression spring cannot be further compressed in that position so that the force exerted by the force storage means 2a remains constant from that position.

If the at least two force storage means 2a, 2b have characteristic curves of differing gradients (that is to say the force F exerted by them plotted against the path S), that affords the defined switching point as the intersection point of the characteristic curves of the force storage means 2a, 2b at the position S₂ (see FIGS. 6a and 6b).

A particularly simple structure for the switch element 1 is afforded if it is provided that the actuating element 3 has at least two portions 3a, 3b which are mounted limitedly movably relative to each other, as is shown by way of example in FIGS. 1 through 5.

In both cases a respective one of the at least two force storage means 2a, 2b which here are in the form of springs is arranged between a mounting location 4, 5 and one of the at least two portions 3a, 3b.

As already stated it may be advantageous if the at least two force storage means 2a, 2b have characteristic curves of differing gradients. In that way it is possible for the one force storage means 2a for example to be made very much weaker than the other force storage means 2b. It will be appreciated however that it would also be conceivable for both force storage means 2a, 2b to be designed with the same characteristic curve (in the case of springs, that would mean with the same spring constant).

Two examples of possible structural configurations of the switch element 1 according to the invention will now be discussed in detail with reference to FIGS. 1 through 5:

It is possible to see in FIG. 1a a switch element 1 according to the invention, from which extend electric lines 7 for the power supply to the switch element 1 and for transmitting the signals from the switch element 1. In this embodiment the switch element 1 has a housing 10 and can be mounted for example in a corner of the furniture body of an article of furniture. In this embodiment the actuating element 3 is surrounded by four light elements 11 (here: light emitting diodes). The light elements 11 are intended to indicate the position of the switch element 1 to a user.

The switch element 1 can be mounted in place by way of a mounting portion 12.

In this embodiment the actuating element 3 has two portions 3a, 3b, the first portion 3a being in the form of a pin.

It is further possible to see two switches 6a, 6b which are disposed on a common circuit board 14 and the function of which will be described in greater detail with reference to FIG. 2.

In this respect FIGS. 2a through 2b show the switch element 1 of FIG. 1 in a sectional view and a detail view in three different operating positions respectively.

In FIG. 2a the switch element 1 is in its neutral position, that is to say a furniture part 8 (not shown) bears against the first portion 3a and is in its closed position. The switch element 1 is not activated. It is possible to see in the detail view that connected to the first portion 3a is a slider element 13 (here in the form of a sleeve) which is so arranged that, upon a movement of the actuating element 3, it can actuate two switches 6a, 6b, in which case upon actuation of a respective one of the two switches 6a, 6b, that involves closure of an electrical contact and transmission of a switching pulse by way of the electric lines 7.

FIG. 2b shows the situation where the movable furniture part 8 has been moved out of the closed position somewhat by a user. As a result it is possible for the first force storage means 2a to urge the first portion 3a of the actuating element 3 out of the housing 10 to the maximum extent. As can be seen from the detail view, as a result the first switch 6a is pushed in by the slider 13 and thus actuated. Consequently by way of the electric lines 7 a triggering signal is sent to a control or regulating device (not shown) of a drive device and ultimately that results in activation of the drive device for further ejection of the furniture part 8.

In contrast thereto in FIG. 2c the furniture part 8 has been further pushed into its closed position. The result of this is that the first portion 3a compresses to its maximum the first force storage means 2a disposed between the first portion 3a and a mounting location 5. In that situation the first portion 3a is in contact with the second portion 3b, with the second force storage means 2b being arranged between the second portion 3b and a mounting location 4. In the position shown in FIG. 2c the second portion 3b has already been moved somewhat by the first portion 3a against the acting force produced by the force storage means 2b and the slider 13 has triggered the second switch 6b. FIG. 2c therefore shows the situation in which the actuating element 3 has assumed the position S₂ representing a defined switching point. As already stated that defined switching point is at the transition from the characteristic curve of the force storage means 2a to that of the force storage means 2b, as shown in FIG. 6a.

FIGS. 3 through 5 show a further embodiment of a switch element according to the invention.

As in the first embodiment the switch element 1 has a housing 10 in which an actuating element 3 is movably mounted. In addition the signals of the switch element 1 can be passed to a control or regulating device (not shown) by way of electric lines 7 or those lines 7 serve for the power supply to the switch element 1.

FIG. 3b shows an exploded view of the switch element 1.

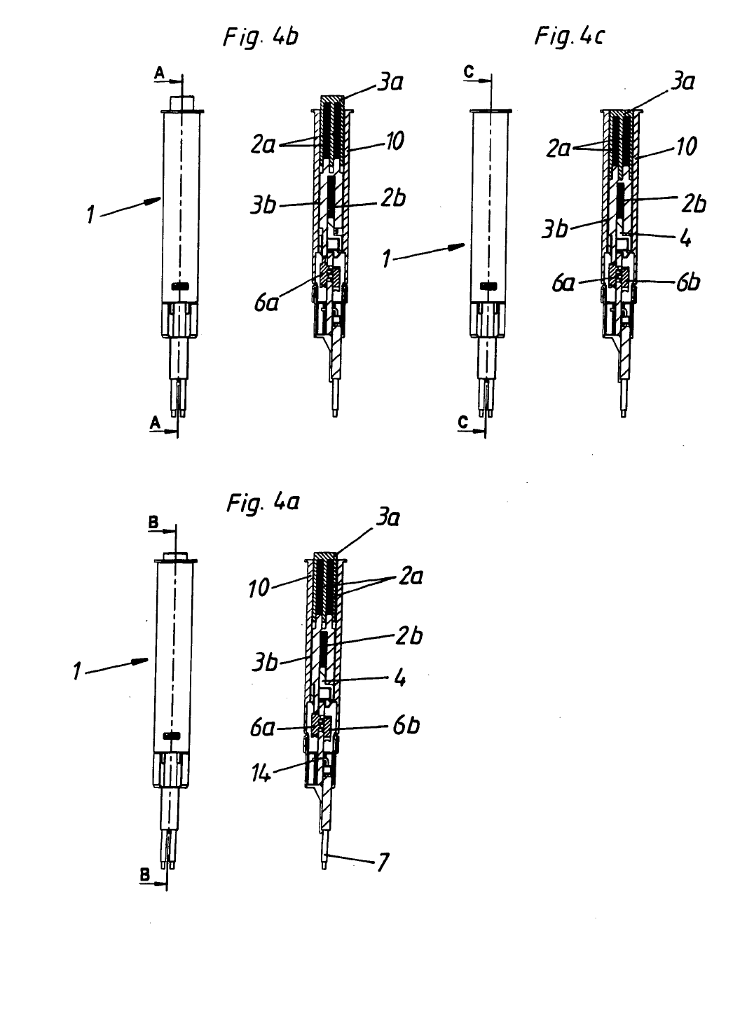

It will be seen that in this embodiment the actuating element 3 also has two portions 3a and 3b. Arranged between the first portion 3a and the second portion 3b in this case at mounting locations 5 are two force storage means 2a which in total operate like a single force storage means 2a. A single force storage means 2b is arranged between the second portion 3b and the mounting location 4a which is provided on a holder 4b fitted on a circuit board 14. Arranged on the board 14 are two switches 6a, 6b which in this embodiment are in the form of toggle switches. The function of the switches 6a, 6b is described in detail with reference to FIGS. 4a through 4c.

FIG. 4a shows the neutral position of the switch element 1 in which the switch element 1 does not emit any signals by way of the lines 7 and the furniture part (not shown) is in the closed position and contacts the first portion 3a of the actuating element. In that position the second portion 3b actuates the first switch 6a. The force storage means 2b between the second portion 3b and the mounting location 4a is compressed to its maximum and the second portion 3b and the holder 4b are in a condition of butting against each other. As already stated the situation shown in FIG. 4 represents the neutral condition of the switch element 1 although the second portion 3b is actuating the first switch 6a. That will be more readily understandable by reference to the following Figures.

FIG. 4b shows the situation in which the furniture part 8 has been moved somewhat out of the closed position by the user. As a result the second portion 3b and therewith the first portion 3a can move out of the housing 10 to the maximum extent under the force applied by the force storage means 2b. It will be seen that the second portion 3b no longer actuates the first switch 6a in that situation. It is precisely that transition from actuation to non-actuation of the first switch 6a that supplies the switching pulse which activates the drive device and further ejects the furniture part 8.

FIG. 4c shows the situation in which the furniture part 8 was moved further into the furniture body from the closed position by the user. As a result the first portion 3a is moved by the maximum into the housing 10 until it bears against the portion 3b. That results in maximum compression of the force storage means 2b (as in FIG. 4a) and further from the position of the first portion 3a that is shown in FIG. 4a, also leads to compression of the force storage means 2a arranged between the first portion 3a and the second portion 3b. Consequently not only the first switch 6a is activated, which however does not involve any consequences (more specifically that switch 6a is in the form of an ‘opener’), but also the second switch 6b is activated (as a ‘closer’), which however cannot be seen from FIG. 4c. By virtue of activation of the second switch 6b, the drive device is triggered and thus the furniture part 8 is ejected.

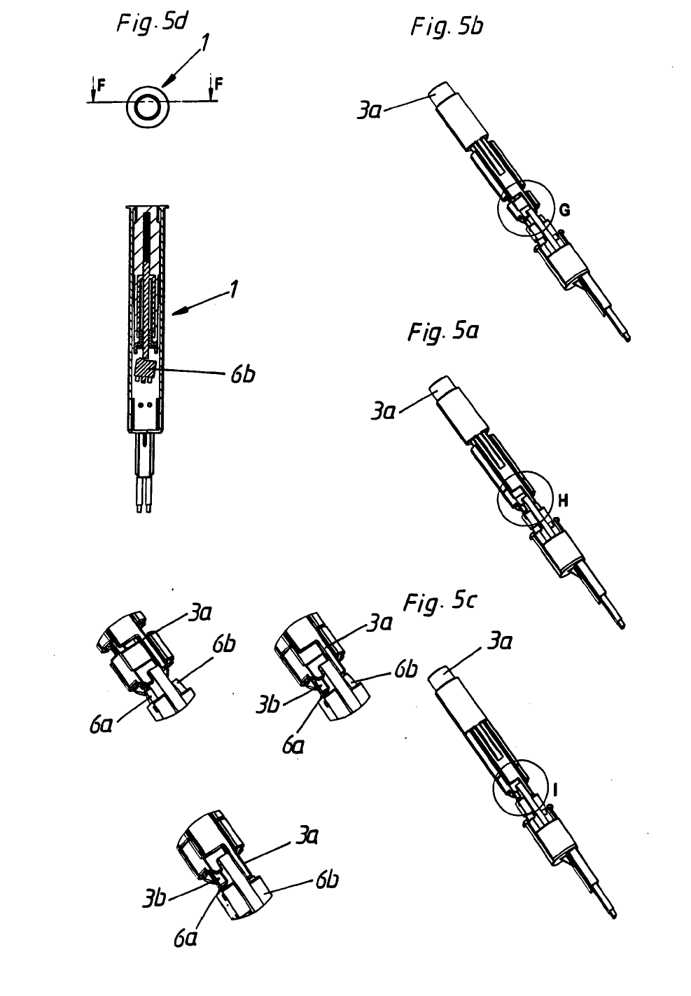

The switching operation will be described once again with reference to FIGS. 5a through 5c.

FIG. 5a shows the neutral position of the switch element 1, in which respect the housing 10 is not shown here. It will be seen from the enlargement H that in this position the first switch 6a is actuated by the second portion 3b while the second switch 6b is not actuated by the first portion 3a.

In FIG. 5b the furniture part 8 and therewith the first portion 3a and the second portion 3b have been moved out. The enlargement G shows that this leads to release of the first switch 6a by the second portion 4b, which actively switches the switch element 1.

FIG. 5c shows the situation when the furniture part 8 is pushed in and with the first portion 3a moved to its maximum into the housing 10 (not shown). The enlargement I shows that now not only does the second portion 3b switch the first switch 6a but also the first portion 3a switches the second switch 6b, which situation is also shown in FIG. 5d as a longitudinal section outside the center line of the switch element 1. That also leads to active switching of the switch element 1.

FIGS. 6a and 6b show two embodiments of the switch element 1, the preferred embodiment 6a using two force storage means 2a, 2b with characteristic curves K₁, K₂ of different gradients. In that respect the characteristic curve K₁ belongs to the force storage means 2a and the characteristic curve K₂ belongs to the force storage means 2b. It will be seen that only the first force storage means 2a acts on the actuating element 3 over the partial travel path between the positions S₁ and S₂. At the position S₂ the force storage means 2a is stressed to its maximum (compressed) and the force storage means 2b comes into butting relationship. A defined switching point is provided at the position S₂ due to the break at the transition from K₁ to K₂.

A second embodiment is shown in FIG. 6b. In this case the characteristic curve K₂ has double the gradient of the characteristic curve K₁. That is to be attributed to the fact that the characteristic curve K₁ is produced only by the action of a single force storage means 2a between the positions S₁ and S₂. That first force storage means 2a however is not yet compressed to its maximum at the position S₂ but can still exert force. It will be noted however that a second force storage means 2b of identical nature comes into contacting relationship at position S₂ so that, from position S₂, the two forces acting on the actuating element 3 are added. Once again at the position S₂ a defined switching point is afforded, in which respect it will be noted that in this embodiment 6b the definition of the switching point is less well defined by virtue of the less pronounced break (angle between the characteristic curves K₁ and K₂).

FIGS. 8 through 10 show a further variant of a switch element 1 according to the invention.

In this variant the defined switching point is achieved by the provision, separately from the actuating element 3, of at least one further element 15 which is acted upon by at least one force storage means 2b.

FIG. 8a shows an embodiment of such a switch element 1. In this case, provided symmetrically beside the actuating element 3 are two elements 15 in the form of pins. It is further possible to see light elements 11.

FIG. 8b shows an exploded view from which it can be seen that the actuating element 3 has a toothed rack extension meshing with the gear 16 of a potentiometer 17 arranged on a circuit board 14. The potentiometer 17 serves in that case to detect a movement of the actuating element 3 and to pass it by way of the electric lines 7 to a control or regulating device (not shown) for triggering a drive device. It will be appreciated that the electric lines 7 also serve for the power supply to the switch element 1.

The two elements 15 are each acted upon by a respective force storage means 2a. In this case each of the two force storage means 2a is shorter than the force storage means 2b, with the result that, without the action of a counteracting force, the actuating element 3 projects furthest from the front panel 18 of the switch element 1.

It is further possible to see from FIG. 8 a cover 19, a cable holder 20′ and two installation pins 21 serving to fix the switch element 1 in a bore in a furniture body or carcass. The electric lines 7 extend protected in a passage 20 which can be placed in a bore in a furniture body.

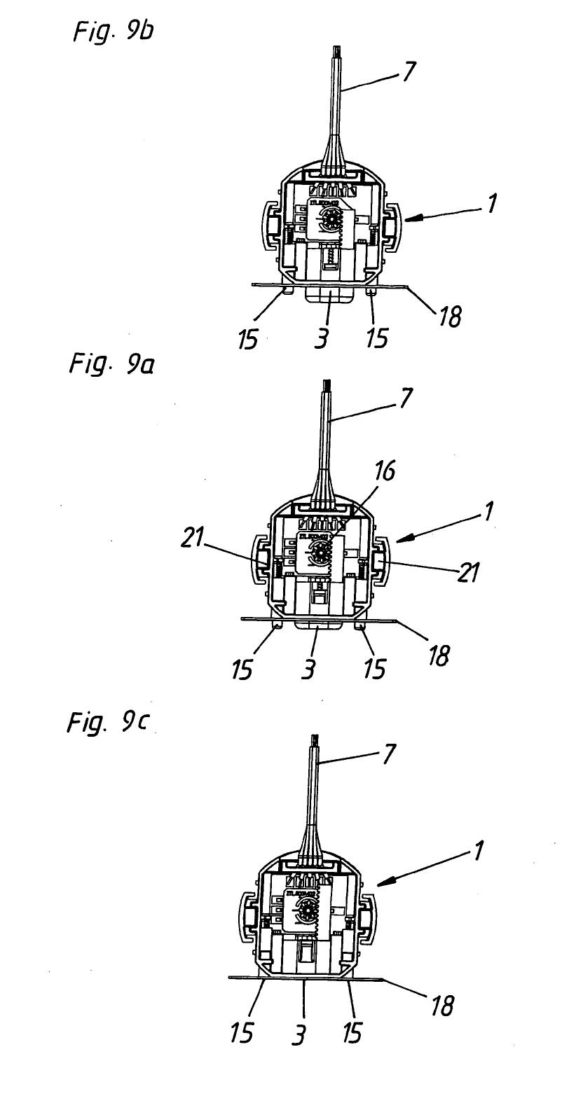

The mode of operation of the switch element shown in FIG. 8 will be described with reference to FIGS. 9a through 9c.

FIG. 9a shows the neutral position of the switch element 1 in which it is not active.

In this case a furniture part 8 (not shown) bears both against the actuating element 3 and also against the elements 15. In that way the actuating element 3 is pressed in to such an extent that it lies in a plane with the elements 15.

FIG. 9b shows the situation after the furniture part 8 has been moved out by a user. The actuating element 3 can now move away from the front panel 18 to the maximum extent under the action of the force storage means 2b. That movement is detected by the potentiometer 17 and leads to triggering of the drive device. In that functionality, the elements 15 play no part.

FIG. 9c shows the situation after the furniture part 8 has been pushed into the furniture body to the maximum extent. As a result both the actuating element 3 and also the elements 15 have moved out of the FIG. 9a position into the FIG. 9c position. Because the user would have to push both the actuating element 3 and also the elements 15 in against the force applied by the respective force storage means 2a, 2b in the transition from the FIG. 9a position into the FIG. 9c position, the user has noted the defined switching point corresponding to the positions shown in FIG. 9a of the actuating element 3 and the elements 15.

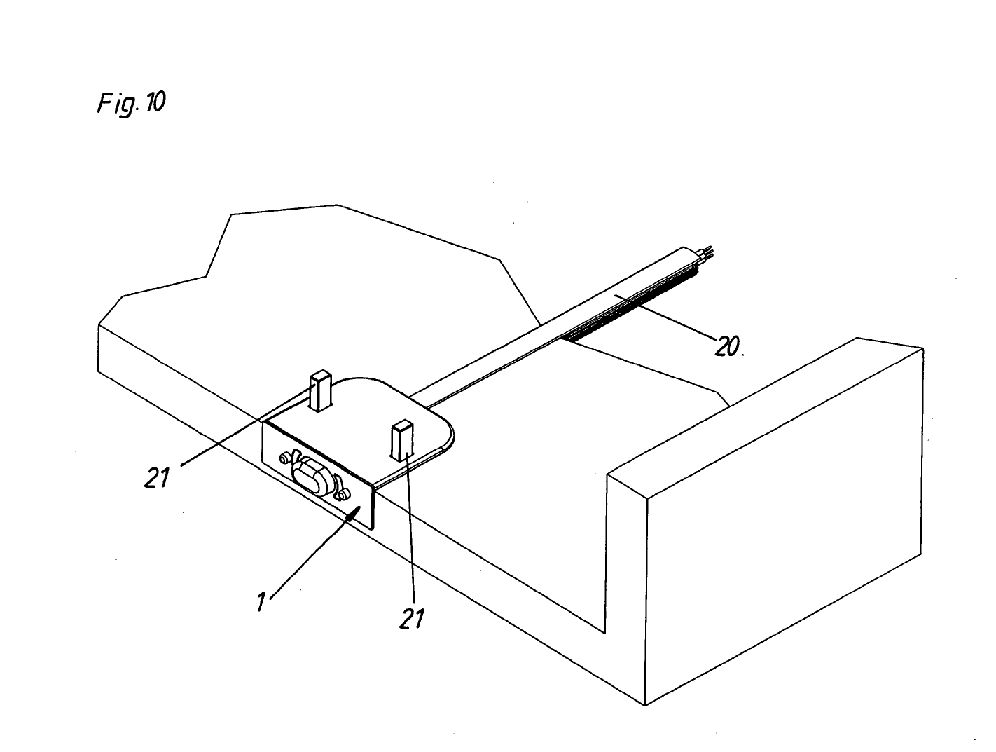

FIG. 10 shows the switching element 1 in the installed condition in a furniture body, but before the holding pins 21 are pushed in for fixing the switch element 1, The potentiometer can be for example in the form of a linear potentiometer or a rotary potentiometer (as shown in the Figures).

1. A switch element comprising:
an actuating element which can be acted upon by a force storage means and which is mounted movably along a path,
at least two force storage means for acting on the actuating element, the number of force storage means acting on the actuating element changing at predetermined positions on the path.

2. A switch element as set forth in claim 1 wherein the actuating element has at least two portions which are mounted limitedly movably relative to each other, wherein a respective one of the at least two force storage means is arranged between a mounting location and one of the at least two portions.

3. A switch element as set forth in claim 1 wherein the at least two force storage means have characteristic curves of different gradients.

4. A switch element as set forth in claim 1 wherein at least one of the at least two force storage means is in the form of a spring.

5. A switch element as set forth in claim 1 wherein two switches switchable by the actuating element are arranged along the predetermined path, the signals of which switches are passed to an interface or electric lines.

6. A switch element as set forth in claim 1 wherein the actuating element and optionally at least one of the at least two portions is in the form of a pin.

7. A switch element comprising:
an actuating element which can be acted upon by a force storage means and which is mounted movably along a path,
at least one element arranged separately from the actuating element and acted upon by at least one force storage means.

8. A drive device for a movable furniture part comprising:
a control and regulating device, the control and regulating device being connected to an interface or electric lines of a switch element as set forth in claim 1.

9. A drive device as set forth in claim 8 wherein there is provided an electric motor for driving the furniture part, the electric motor being triggerable by the control and regulating device.

10. A drive device as set forth in claim 9 wherein there are provided at least two force storage means for acting on the actuating element and the number of force storage means acting on the actuating element changes at predetermined positions on the path, whereby the gradient of the characteristic curve changes at said positions, of which positions a position in the interior of the path is in the form of a switching point of the switch element.

11. An article of furniture comprising:
a movable furniture part and a drive device as set forth in claim 8.

12. An article of furniture as set forth in claim 11 wherein in its closed position the furniture part bears against the actuating element of the switch element.
